(19) United States
(12) Patent Application Publication
(10) Pub. No.: US 2016/0319494 A1
(43) Pub. Date: Nov. 3, 2016

(54) Portable Mastic Sealer Production

(71) Applicant: Crown Beds, Inc., West Plains, MO (US)

(72) Inventors: Gary Henry Foster, West Plains, MO (US); Gary Randall Foster, West Plains, MO (US); Rodney Glendall Foster, West Plains, MO (US)

(21) Appl. No.: 15/140,670

(22) Filed: Apr. 28, 2016

Related U.S. Application Data
(60) Provisional application No. 62/153,972, filed on Apr. 28, 2015.

(51) Int. Cl. E01C 19/10; B01F 9/00; B01F 15/02; B01F 13/00; B01F 7/00

(52) U.S. Cl. CPC E01C 19/104; B01F 13/004; B01F 7/0025; B01F 15/0283; B01F 15/0243; B01F 7/00; B01F 9/00; E01C 2019/1081; B01F 2215/0047

(57) ABSTRACT

The present invention is directed to an apparatus and method comprising a portable mastic sealer production process which allows an operator to locate the mastic sealer production equipment in the vicinity of the roadway worksite. The apparatus comprises two mobile trailers, one comprising the clay plant and the other comprising the mastic plant. The clay plant is a trailer based mobile mixing plant with a mixing tank for mixing proportioning and mixing a clay slurry which is then stored in a clay slurry storage tank. The mastic plant is a trailer based mobile mixing plant which mixes the clay slurry received from the mobile clay mixing plant with polymers, aggregate and other desired additives to form the mastic sealant. The mixed sealant is then transferred to a finished mastic storage tank or spraying equipment to provide an available supply of mastic sealant for operations at the roadway worksite.

### CROSS-REFERENCE TO RELATED APPLICATIONS

This application claims the benefit of and priority to U.S. provisional patent application, U.S. Ser. No. 62/153,972, filed with the U.S. Patent & Trademark Office on Apr. 28, 2015, the disclosure of which is incorporated by reference herein as if fully set forth at length.

### BACKGROUND OF THE INVENTION

The majority of federal and state highway agencies and municipalities must build and maintain large road networks that are predominately paved with an asphalt surface. These agencies have multiple issues they must contend with in keeping roadways maintained and in safe working order, namely:
1. Shrinking road budgets;
2. Increasing material costs; and
3. Rapid asset deterioration.

A large contributor to this rapid asset deterioration is occurring because these agencies are trying to lower material costs by utilizing recycled asphalt pavement (RAP) and recycled asphalt shingles (RAS) in the maintenance of existing roadway surfaces. The RAP and RAS are contributing to asphalt roads oxidizing more rapidly, thus leading to more brittle pavement structure, which in turn leads to cracking, water intrusion, resulting in accelerated pavement failure. Hot mix overlays that have previously lasted 10-12 years are now typically failing within 6-7 years after application.

The foregoing issues have caused groups in the asphalt industry to develop a heavy mastic asphalt sealer that operates to halt or at least slow the rate of oxidation the pavement structure is experiencing. These mastic sealers are gaining in popularity and usage by highway agencies and roadway contractors. It is expected that all 50 states will be predominately using mastic asphalt sealer products within a few years.

The current practice is to build a stationary plant to produce these sealers (all of different designs), then transport the sealer product long distances (hundreds of miles) by truck or rail to where it is unloaded, remixed, and then placed on the highway or road. However, the problems associated with this approach are based on economics and product quality. Mastic sealers use water as a vehicle to carry the asphalt and other ingredients to the road surface where the water then “breaks” out of the emulsion and evaporates, leaving the asphalt, polymers, and aggregate to coalesce on the pavement to form the desired seal on the pavement. Increased transportation costs resulting from hauling water, in addition to the premixed sealer, to the roadway worksite results in increased expense. The quality issue stems from the long distance transport of the mastic sealer product from the plant to the roadway worksite. The mastic chemical characteristics typically result in a breakdown of the sealer into constituent components during transport to the roadway worksite that leaves a segregated product in the transport trailer. To date, this problem has been treated by pumping the segregated product from the transport tank into a portable storage tank located at the roadway worksite with a mixer that blends the product back together. This works fairly well in a perfect environment, but workers can mishandle the re-blending process, thus resulting in a remixed mastic product that does not meet the job specifications. The current practice of transporting pre-mixed mastic to the worksite for application is generally satisfactory up to a 100 mile radius from the plant where the mastic is mixed. However, chemical and mixing problems start to appear when the pre-mixed mastic product is transported over distances more than 100 miles from the mixing plant.

There is a need in the art for an apparatus and method for the portable production of a mastic sealer product providing for mixing the mastic sealer precursors and forming the mastic sealant mix at or near the vicinity of the roadway worksite so as to reduce the time and distance required for transporting the pre-mixed mastic sealant to the roadway worksite and depositing the mixed mastic sealant on to the roadway surface. Further, there is a need for a portable mastic sealer production apparatus and method that enables the production of a pre-mixed mastic sealant that meets roadway specifications at or in the vicinity of the roadway worksite. The present invention addresses these shortcomings as well as others, as will be demonstrated to one of ordinary skill in the art after a thorough reading and understanding of the detailed description herein.

### SUMMARY OF THE INVENTION

The present invention is directed to an apparatus and method comprising a portable mastic sealer production process which allows an operator to locate the mastic sealer production equipment to the vicinity of the roadway worksite. In general, the apparatus comprises two truck trailers, one comprising the clay plant and the other comprising the mastic plant. The clay plant is a trailer based mobile mixing plant with a mixing tank for mixing proportioning and mixing a clay slurry which is then stored in a clay slurry storage tank. The necessary pumping, auger and hosing equipment is attached to the trailer to aid in the mixing and transfer to the clay slurry between the mixing tank, clay slurry storage tank and any other mixing, storage, holding or deposition equipment as may be required. The mastic plant is a trailer based mobile mixing plant which mixes the clay slurry received from the mobile clay mixing plant with polymers, aggregate and other desired additives to form the mastic sealant. The mixed sealant is then transferred to a finished mastic storage tank to provide an available supply of mastic sealant for operations at the roadway worksite.

In an embodiment, the present invention also includes a trailer mounted housing for a quality control or quality assurance laboratory for providing chemical sampling of the mastic sealant produced by the indicated apparatus and method so as to insure the resulting mastic sealer meets the job specifications required by the overseeing highway agency.

### BRIEF DESCRIPTION OF THE DRAWINGS

The present invention will be more readily understood by reference to the following detailed description read in conjunction with the accompanying drawings, wherein:

FIG. 1 is a depiction of an embodiment of the clay plant mounted on a trailer of the present invention disclosed herein;

FIG. 2 is a depiction of an embodiment of the mastic plant mounted on a trailer of the present invention disclosed herein; and,

FIG. 3 is a depiction of an embodiment of a mastic sealant storage tank mounted on a trailer of the present invention disclosed herein.

### DETAILED DESCRIPTION OF THE INVENTION

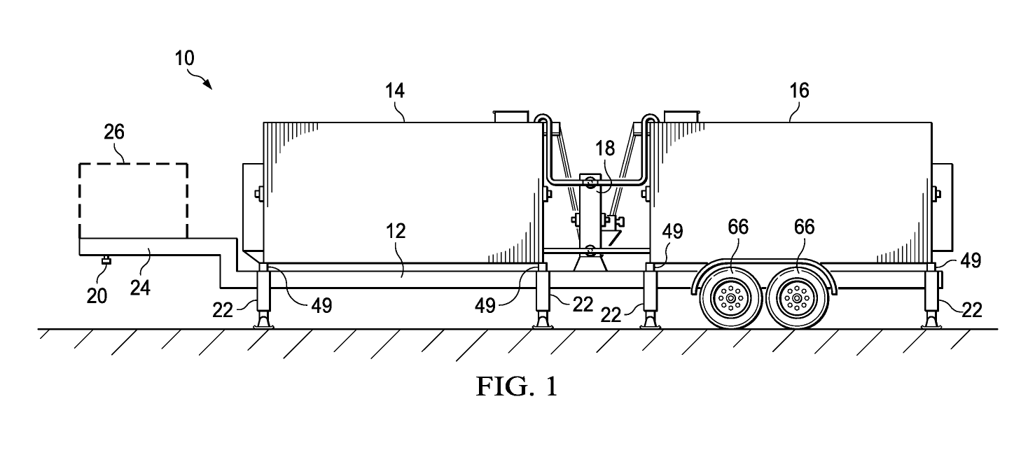

Turning to FIG. 1, the clay plant 10 consists of a common frame 12 with wheeled axles 66 and with two tanks 14, 16, attached to frame 12. Tank 14 is equipped with a scale system for proportioning the clay slurry ingredients which are mixed therein and transferred to tank 16 when the mastic plant is running production. Water is pumped into the clay mixer tank 14 and weighed as a specially designed paddle mixer turns inside the tank 14. Dry, powdered clay and any other additives are added and weighed according to the required mixing formula by means of either a telehandler forklift for dumping super sacks, or a bin with an auger. Alternatively, a pre-made clay slurry may be pumped into the mixing tank 14 for dilution.

Next, the clay slurry is agitated/mixed for a set time in mixing tank 14 and then held in mixing tank 14 for a required number of hours to let the slurry hydrate. After the hydration time has elapsed, the clay slurry is then transferred over to the clay slurry storage tank 16, via pump 18 and necessary hosing or piping (not shown), both of which are also mounted to frame 12. Transfer pump 18 is mounted between the tanks 14, 16 with the appropriate valveworks and hosing/piping. Trailer frame 12 is equipped with a king pin 20 for hooking onto a truck tractor, trailer axles, lights, air plumbing, etc. for transporting the unit 10. Trailer frame 12 is also equipped with jacks 22 (landing gear) that are positioned under the load cells 49 and corners of the mixing and storage tanks to eliminate flexing and instability. These jacks 22 can be manually, hydraulically, pneumatically, and/or power driven. This will allow the load cells 49 to function appropriately as designed by the scale manufacturer. On the neck 24 of the trailer frame 12, above the king pin 20, is an optional location for a hydraulic pump or generator 26, for use in connection with operating the jacks 22 or any other equipment utilized in connection with production operations.

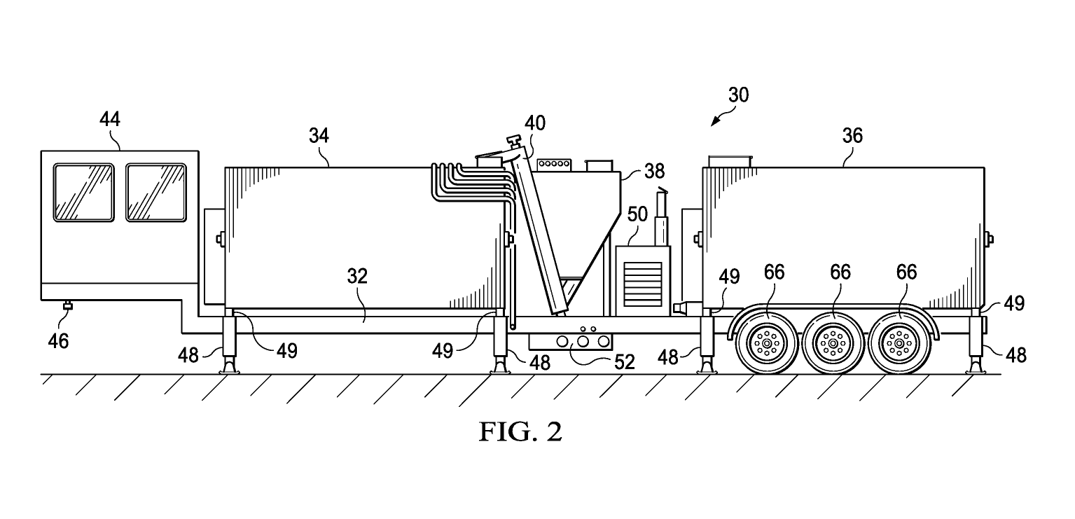

With reference to FIG. 2, the mastic plant 30 consists of a common frame 32 that contains a mastic mixer 34 with a scale system, aggregate bin 38 and aggregate auger 40, an engine driven hydraulic pump or generator 42, additive pumps, asphalt emulsion pump, water pump, control house 44 and controls, a quality control/quality assurance (QC/QA) testing lab, and a finished mastic storage tank 36 with scale system. When producing mastic sealer, clay slurry is pumped from the clay slurry storage tank 16 into the mastic mixer 34. A mixing paddle (not shown) turns inside the mastic mixer 34 to blend all the ingredients according to the specified formula. Alternatively, mastic mixer 34 may comprise a rotary drum style mixer or a ribbon blender mixer as are known in the art. After the clay slurry has been added, any required additional polymers and additives are pumped off of transport trailers using an additive pump into the mastic mixer 34. Next, aggregate is conveyed from the aggregate bin 38 into the mastic mixer 34 by means of the aggregate auger 40.

After the required mixing time has elapsed, a sample of the finished product is taken to the QC/QA lab (located in the control house) for testing. After testing is complete, the finished product is transferred into the finished mastic storage tank 36. Mastic storage tank 36 can be equipped with legal for trade scales and weighs the product pumped into transport trailers at the point of sale. The ticketing equipment is also located in the control house 44. The trailer frame 32 is equipped with a king pin 46 for hooking onto a truck trailer, trailer axles 66, lights, and air plumbing, for transporting the unit 30. The frame 32 is also equipped with jacks 48 (landing gear) that are positioned under the load cells 49 and corners of the storage tank 36 to eliminate flexing and instability. These jacks 48 can be manual, hydraulic, or power driven. This will allow the load cells 49 to function as designed by the scale manufacturer. The engine 50 for driving the hydraulic pump or generator is mounted between the aggregate bin 38 and mastic storage tank 36. The mastic plant 30 can be equipped with multiple type mixers; a ribbon blender type mixer, a rotary drum type mixer, or a paddle type mixer.

During operations, the mastic plant 10 is placed in fluid communication with the clay plant 30, transport trailers, water meter, finished product tanks 60, and/or other support units by appropriate hosing/piping (not shown) as required to facilitate operation and movement of the clay slurry, aggregates, additives and mastic sealant product. Piping and valveworks 52 (powered and manual) are used on the mastic plant 30 to control the flow of product between tankage for storage or transfer to spray equipment for dispensation on the roadway worksite. The control house 44 is central to both the clay plant 10 and the mastic plant 30. All machinery controls, computer controls, ticket printing, and QC/QA testing equipment are housed in the control house 44. A computerized control system is also available that will assist the operator in mixing product. This system also records and reports the mixing activity of the plant back to a central office to management can keep track of activities in the field.

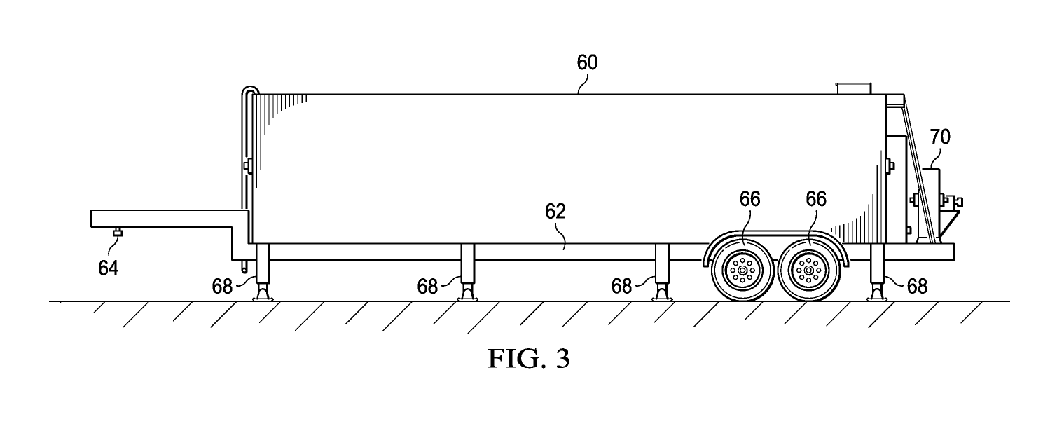

Alternatively as shown in FIG. 3, the finished product can be pumped into a larger finished product storage tank 60 for storage. This eliminates delays caused by surges in roadway application and allows the production level to be maintained with reserve capacity of mastic sealant stored in the tank 60 to compensate for surges in production requirements. One or more storage tanks 60 may be used depending on the size of the project. Tank 60 is mounted on a trailer frame 62 with kingpin 64, axles 66, electrical and air brake components and support jacks 68. Pump 70 is located on trailer frame 62 an is utilized to transfer mastic sealant into or out of tank 60 as desired. Tank 60 can also be mounted on trade scales to be a point of sale to other road service vendors operating in the vicinity.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

We claim:

1. An apparatus, comprising:
a clay plant attached to a trailer comprising a clay slurry mixing tank with a paddle mixer disposed inside the clay slurry mixing tank and the clay slurring mixing tank is in fluid communication with a slurry storage tank; and,
a pump for transferring a clay slurry from the slurry mixing tank into the slurry storage tank.

2. The apparatus of claim 1, further comprising:
a load cell attached to the trailer.

3. The apparatus of claim 1, further comprising:
a jack attached to the trailer.

4. The apparatus of claim 1, further comprising:
an auger in mechanical communication with an additive storage bin for introducing a powdered clay or other additive into the clay slurry mixing tank.

5. The apparatus of claim 1, further comprising:
a mastic plant attached to a second trailer comprising a mastic mixer tank in fluid communication with a mastic storage tank;
an auger in mechanical communication with an aggregate storage bin for introducing aggregate into the mastic mixer tank to produce a mastic; and,
a pump for transferring the mastic from the mastic mixer tank into the mastic storage tank.

6. The apparatus of claim 5, further comprising:
a load cell attached to the second trailer.

7. The apparatus of claim 5, further comprising:
a jack attached to the second trailer.

8. The apparatus of claim 5, further comprising:
a control house attached to the second trailer.

9. The apparatus of claim 5, further comprising:
a second mastic storage tank attached to a third trailer.

10. The apparatus of claim 5 wherein the mastic mixer comprises a ribbon blender mixer, a rotary drum mixer or a paddle mixer.
